(19) United States
(12) Patent Application Publication
(10) Pub. No.: US 2015/0108851 A1
(43) Pub. Date: Apr. 23, 2015

(54) PHOTOVOLTAIC SYSTEMS WITH SHAPED HIGH FREQUENCY ELECTRIC PULSES

(71) Applicant: UltraSolar Technology, Inc., Santa Clara, CA (US)

(72) Inventor: Santosh Kumar, San Jose, CA (US)

(21) Appl. No.: 14/519,120

(22) Filed: Oct. 20, 2014

Related U.S. Application Data
(63) Continuation-in-part of application No. 14/449,000, filed on Jul. 31, 2014.
(60) Provisional application No. 61/893,199, filed on Oct. 19, 2013.

(51) Int. Cl. H02J 3/38

(52) U.S. Cl. CPC H02J 3/383
USPC 307/106

(57) ABSTRACT

At least one photovoltaic (PV) cell comprising a semiconductor material having p-n junctions formed therein, and configured to generate a PV output voltage in response to light; and a pulse generator coupled to receive a PV output voltage and generate electric output pulses therefrom, and apply such pulses to the PV cell.

This application claims the benefit of U.S. provisional patent application Ser. No. 61/893,199, filed on Oct. 19, 2013, and is a continuation-in-part of U.S. patent application Ser. No. 14/449,000 filed on Jul. 31, 2014, which claims the benefit of U.S. provisional patent application Ser. No. 61/891,899, filed on Oct. 17, 2013, the contents all of which are incorporated by reference herein.

### TECHNICAL FIELD

The present disclosure relates generally to photovoltaic (PV) based cells, and particularly to the application of electric pulses to improve the power output of such solar cells.

### BACKGROUND

Photovoltaic (PV) cells are devices that produce electricity when subjected to light. Photons from light can create electrons and holes in solar cells. Electrons and holes are swept to electrodes by the electric field of p-n junctions formed by a semiconductor material within the solar cells. Electrons in the valance band require energy equivalent to the band gap of the semiconductor to conduct by jumping from a valence band to a conduction band. Electrons in the conduction band contribute to the electricity generated by PV cells.

High energy photons can generate “hot” electrons/holes which give up their energy in the form of heat and often do not contribute to electricity produced by the PV cell. Electrons/holes which absorb high energy photons can become highly energetic or “hot carriers” (or hot excitons) and collide with a lattice site of the semiconductor material and lose energy. The excess energy of hot carriers can be lost as phonons.

It has been reported that if all hot carriers of conventional PV cell were captured at the electrode, cell efficiency could be doubled.

The capture of hot carriers has proven to be difficult using conventional techniques. A conventional hot carrier device (i.e., a device which converts hot carriers into electricity) typically has stringent requirements: (1) a need to slow the thermalization of the photogenerated electrons (and holes) in the absorber material; (2) the extraction of the hot carriers to external contacts over a narrow range of energies, such that the excess carrier energy is not lost to the contacts; and (3) the integration of requirements (1) and (2) into a working device that does not compromise performance.

Conventionally, the extraction of hot carriers has utilized selective gates, which can require very advanced processing methods and structures, such as quantum dots, etc. In such approaches, selective energy contacts can extract charge through a narrowly aligned energy range. Quantum mechanical resonant tunneling structures are most likely to meet such a requirement of a selective energy transmission over a small energy range.

To slow thermalization, it has been proposed to employ phonon engineering to the photon absorbing material. Phonon engineering can require complex or expensive materials and/or manufacturing processes.

### SUMMARY

According to embodiments, electric pulses can be shaped and applied to a semiconductor material of a photovoltaic (PV) cell to capture hot carriers that might otherwise be lost to thermalization (collision with a lattice site).

Within a PV cell material, phonons of appropriate energy can reduce thermalization. Further, phonons with appropriate energy can increase the lifetime of hot carriers within the material, and thus enable the capture of greater numbers of such hot carriers. In some embodiments, the potential barrier due to an optical phonon energy gap can be modified by application of electric pulses that are shaped by a pulse shaping circuit.

According to embodiments, electrons of different energies, can be captured by varying the electric pulse applied to a PV material. In some embodiments, such electrons can be hot electrons.

According to embodiments, application of electric pulses to a PV cell can lower a potential barrier arising from a phonon energy gap of a material cell, resulting in modified electric pulses at an electrode of the PV cell. In some embodiments, such modification can result in an increase of electric current generated by the PV cell, as compared to the PV cell without the application of such pulses.

According to embodiments, electric pulses applied to the PV cell can be high frequency electric pulses with large amounts of power per pulse, such as several kilowatts or more.

According to embodiments, electric pulses for application to the PV cell can be generated from one or more pyroelectric materials. In particular embodiments, such pyroelectric materials can include a stack of pyroelectric thin films.

According to embodiments, electric pulses applied to a PV cell can be shaped by a pulse shaping circuit having a timer to control a duration of a pulse sequence.

According to embodiments, electric pulses applied to a PV cell can be controlled by a pulse shaping circuit controlled by relay inputs.

According to embodiments, electric pulses applied to a PV cell can be shaped by a pulse shaping circuit that modulates electric pulses with other electric pulses.

### BRIEF DESCRIPTION OF THE DRAWINGS

The embodiments disclosed are shown by way of example and not limitation in the described figures. In the described figures, like reference indicate similar elements.

FIG. 1 is a block diagram of a PV cell based energy generation system according to an embodiment.

FIG. 2 is a block diagram of a PV cell based energy generation system according to an embodiment.

FIG. 3 is a block diagram of a PV cell based energy generation system according to an embodiment.

FIG. 4 is a block diagram of a PV cell based energy generation system according to an embodiment.

FIG. 5 is a block diagram of a PV cell based energy generation system according to an embodiment.

FIG. 6A is a block diagram of a pulse generator according to an embodiment.

FIG. 6B is a side cross sectional representation of pyroelectric materials that can form part of a pulse generator according to an embodiment.

FIG. 7 is a block schematic diagram of a pulse generator according to another embodiment.

FIGS. 8A to 8C are diagrams showing the generation of electric pulses with pyroelectric materials that can be included in embodiments.

FIG. 9 is a block schematic diagram of a pulse shaper circuit that can be included in embodiments.

FIG. 10 is a block schematic diagram of another pulse shaper circuit that can be included in embodiments.

FIGS. 11A and 11B are schematic diagrams showing a pulse shaper circuit that can be included in embodiments.

FIG. 12 is a diagram showing the generation of a hot electron in PV solar cell material.

FIG. 13A is a diagram showing how the energy of a hot carrier can be lost by collision within a semiconductor lattice of a photovoltaic (PV) solar cell. FIG. 13B is a diagram showing how a hot carrier can be collected in a PV solar cell according to an embodiment.

FIG. 14 is a diagram showing how the energy of a hot carrier can be lost to thermalization in a semiconductor material of a PV solar cell.

FIG. 15 is a graph showing how conduction in an indirect semiconductor can be assisted by phonon action.

FIG. 16 is a diagram representing a band gap of an indirect semiconductor material that includes both an electronic band gap, as well as a “phonon” band gap.

FIG. 17 is a diagram showing the electronic and phonon band gap of a semiconductor material.

FIG. 18 is a diagram showing how the electronic and phonon band gap can be modified by application of electric pulses to the semiconductor material.

FIGS. 19A and 19B are diagrams showing how electric pulses can increase the conductivity of carriers within a semiconductor material.

FIG. 20 is a graph showing of simulation results demonstrating how application of voltage pulses can increase the current output of a PV solar cell.

FIG. 21 is a graph showing an electron-lattice collision time versus the wavelength of an incident photon.

### DETAILED DESCRIPTION

Embodiments disclosed herein show systems and methods in which electric pulses can be generated and shaped before being applied to a photovoltaic (PV). In some embodiments, high energy electric pulses applied to a PV cell can enable the extraction of highly energetic (e.g., hot carrier) electrons (or holes) that might otherwise be lost (e.g., by collisions within the crystal lattice of the semiconductor).

In very particular embodiments, a phonon energy cap of a PV cell material can be altered to increase lifetime of hot carriers and/or vary the bandgap of the PV cell material to enable the capture of a carriers having a wider energy range.

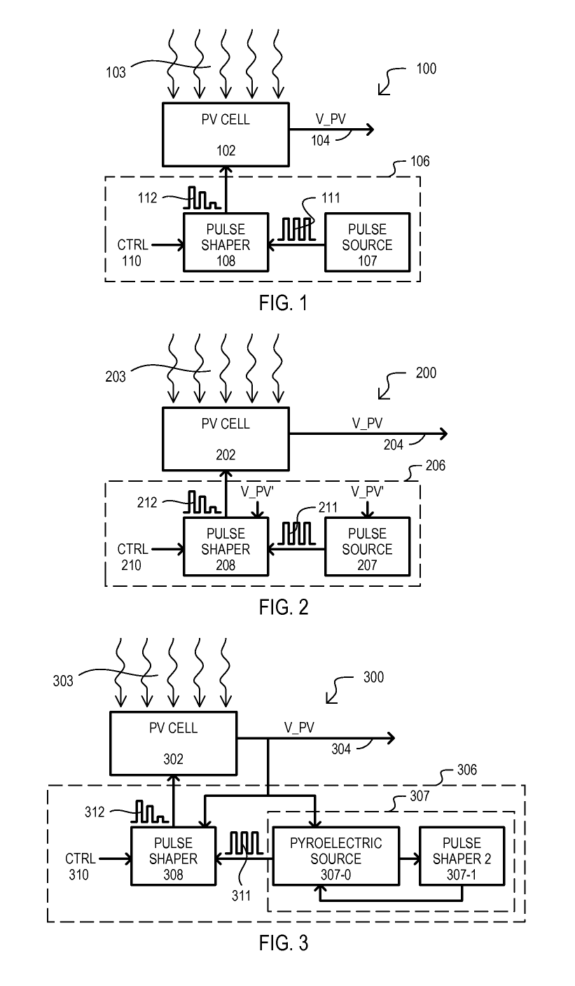

FIG. 1 shows a system 100 according to one embodiment. A system 100 can include a PV solar cell 102 and a pulse generator 106. A PV solar cell 102 can include one or more semiconductor materials having a p-n junction formed therein. The semiconductor material(s) can have a band gap. Incident light 103 (e.g., sunlight) can provide photons which generate electrons (and holes) to produce power on a PV output 104, including an output voltage (V_PV) and current.

A pulse generator 106 can include a pulse source circuit 107 and a pulse shaper circuit 108. A pulse source circuit 107 can provide source electric pulses 111 to pulse shaper circuit 108.

A pulse shaper circuit 108 can modify source electric pulses 111 to generate output electric pulses 112. Such modification of the source electric pulses 111 can include altering pulse duration, magnitude, phase, frequency, modulating such source electric pulses with another waveform, or vice versa. A pulse shaper circuit 108 can be controlled by a control input 110. By application of one or more control signals (CTRL) at a control input 110, the operation of pulse shaper circuit 108 can be controlled. By way of example only, according to control signal(s) (CTRL), output pulses 112 can be enabled or disabled and/or the manner in which source electric pulses 111 are modified can be varied.

Resulting output electric pulses 112 can be applied to PV cell 102 to vary the properties of the photovoltaic material(s) making up the PV cell 102. As noted above, such alteration can include changing phonon properties of the material, including altering band gap energy(ies) of the materials, including lowering potential barriers presented by phonon band gap(s). By application of shaped electric pulse 112, PV cell 102 can alter PV cell output 104, including but not limited to: an increase in output power, a change in output current, or a change in output voltage.

According to some embodiments, output electric pulses 112 can be high frequency and high energy pulses. A high frequency pulse can be a pulse greater than 100 kHz, in some embodiments greater than 500 kHz, and in particular embodiments about 1 MHz A high energy pulse can provide no less than 500 Watts, in some embodiments, no less than a kilowatt (kW), and in particular embodiments, no less than a few kW.

In one very particular embodiment, a pulse can be about 30 V, 2 A and 1 MHz, for a pulse that carries about 60 megawatts per pulse.

According to some embodiments, a pulse generator that applies output electric pulses to a PV cell can receive a power supply voltage from a PV cell. The pulse generator can receive the power supply voltage from the same PV cell to which is applies output electric pulses, or it can receive a power supply voltage from a different PV cell.

FIG. 2 shows a system 200 according to another embodiment. A system 200 can include items like those of FIG. 1, and in some embodiments, can be one implementation of that shown in FIG. 1.

Referring to FIG. 2, A PV solar cell 202 can operate in a fashion like 102 of FIG. 1, including having semiconductor material(s) that can have properties that are modified by application of electric pulses.

In the embodiment of FIG. 2, a pulse generator 206 can include a pulse shaper circuit 208 and pulse source circuit 207, as in the embodiment of FIG. 1. However, in FIG. 2, pulse shaper circuit 208 can receive power from a power supply voltage V_PV′. A power supply voltage can be from a PV cell, such as 202, or another PV cell (not shown), such as one grouped with PV cell 202. In some embodiments, a pulse source circuit 207 can also receive a power supply voltage V_PV′.

In this way, all or a portion of a pulse generator 106 can receive power from the PV cell to which it applies output electric pulses, or from another PV cell.

According to some embodiments, a source of electric pulses applied to a PV cell can be generated by the use of one or more pyroelectric materials. Pyroelectric materials can generate electric energy (e.g., temporary voltage) when they are subjected to a change in temperature (e.g., heated or cooled). However, in addition, when an electric field is applied to a pyroelectric material, a temperature gradient can be produced (i.e., a reverse pyroelectric effect).

In particular embodiments, a temperature gradient in one pyroelectric material produces an electric field, and such an electric field can be used to polarize a second pyroelectric material. The second pyroelectric material can be discharged, and then the process can repeat itself. Such operations can create an oscillating electric field (i.e., electric pulses). Such pulses can be conditioned (e.g., shaped, grouped, amplified, reduced, or modulated) before being applied to a PV solar panel.

FIG. 3 shows a system 300 according to another embodiment. A system 300 can include items like those of FIG. 1, however, a pulse source 307 can be a pyroelectric based pulse source. That is, pulses provided by pulse source 307 can be derived from one or more pyroelectric materials.

A PV cell 302 can operate in a fashion like 102 of FIG. 1 or equivalents.

In the particular embodiment of FIG. 3, a pulse source circuit 307 can include a pyroelectric pulse source circuit 307-0 and a pulse shaper circuit 307-1. A pyroelectric pulse source circuit 307-0 can generate pulses based on one or more pyroelectric materials. As noted above, in some embodiments, different pyroelectric materials can be used in combination, along with an applied voltage source to generate an oscillating signal from such pyroelectric materials. In the embodiment shown, an output voltage V_PV from PV cell 302 can be applied to pyroelectric material(s) within the pyroelectric pulse source circuit 307-0 to polarize the pyroelectric material. While embodiments can include multiple pyroelectric materials, a pyroelectric pulse source circuit 307-0 could include one such material operating in combination with other materials or circuits to generate a pulse.

Referring still to FIG. 3, a pulse shaper circuit 307-1 can shape pulses generated from pyroelectric pulse source circuit 307-0 and feed them back to the pyroelectric pulse source circuit 307-0. A pulse shaper circuit 307-1 can modify pulses in any suitable manner, including but not limited to pulse duration, magnitude, phase, frequency, and/or can modulate pulses.

In the embodiment of FIG. 3, both a pulse shaper circuit 308 and a pulse source circuit 307 can receive a power supply voltage V_PV from the PV cell 302 that receives their output pulses 312.

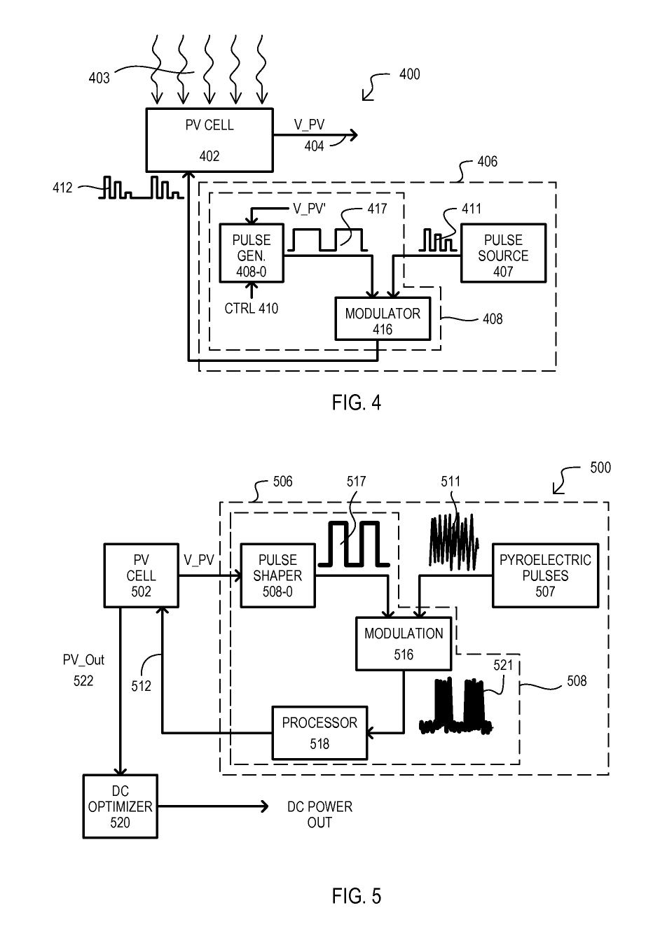

According to some embodiments, a pulse shaper circuit can generate electric pulses from the output voltage of a PV cell, and use such pulses to modulate other pulses provided from a pulse source circuit. Resulting modulated pulses can be output pulses applied to the PV cell. One such embodiment is shown in FIG. 4.

FIG. 4 shows a system 400 according to another embodiment. A system 400 can include items like those of FIG. 1, including a PV cell 402 and pulse generator 406. However, in the embodiment of FIG. 4, a pulse shaper circuit 408 of pulse generator 406 can include a pulse generator circuit 408-0 and a modulator 416.

A PV cell 402 can operate in a fashion like 102 of FIG. 1, or equivalents.

A pulse source circuit 407 can provide first electric pulses 411 to pulse shaper circuit 408 as described for embodiments herein, or equivalents.

Within pulse shaper circuit 408, a pulse generator circuit 408-0 can generate second electric pulses 417 utilizing a power supply voltage V_PV′. In particular embodiments, pulse generator circuit 408-0 can generate second electric pulses 417 by selectively connecting a power supply voltage V_PV′ to an output node. As in other embodiments described herein, a power supply voltage V_PV′ can be that provided by PV cell 402, or that provided by another PV cell (not shown). Pulse generator circuit 408-0 can operate according to control signal(s) (CTRL) at a control input 410. By way of example only, according to control signal(s) (CTRL), second electrical pulses 417 can be enabled or disabled and/or the manner in which second electrical pulses 417 are modified can be varied.

A modulator 416 can modulate first electric pulses 411 with second electric pulses 417 to generate output pulses 412 which can be applied to PV cell.

While FIG. 4 shows particular waveforms for first electrical pulses 411, second electrical pulses 417, and output pulses 412, such waveforms should not be construed as limiting.

FIG. 5 shows a system 500 according to another embodiment. A system 500 can include a PV cell 502, a pulse generator 506, and a DC optimizer 520.

A PV cell 502 can operate in a fashion like 102 of FIG. 1, or equivalents.

A pulse generator 506 can include a pyroelectric pulse source 507 and a pulse shaper circuit 508. A pyroelectric pulse source 507 can generate first electric pulses 511 using one or more pyroelectric materials, as described herein or equivalents.

A pulse shaper circuit 508 can include a pulse generator circuit 508-0, modulator 516, and processor 518. A pulse generator 508-0 can generate second electric pulses 517 from a PV cell output voltage V_PV provided from PV cell 502. In some embodiments, second electric pulses 517 can be generated by coupling PV cell output voltage V_PV to a generator output node for predetermined durations. In one embodiment, pulse durations of second electric pulses 517 can be longer than those of first electric pulses 511. Modulator 516 can modulate first electric pulses 511 according to second electric pulses 517 to generate modulated electric pulses 521. In one very particular embodiment, which should not be considered limiting, modulated electric pulses 521 allow first electric pulses 511 to be active while second electric pulses 517 have one value (e.g., are high). However, this represents but one modulation scheme. Processor 518 can further process modulated electric pulses 521 to produce output electric pulses 512 for application to PV cell 502. Such processing include, but is not limited to, further changes in pulse duration, magnitude, phase, frequency, and/or additional modulation.

In response to output pulses 512, PV cell 502 can provide electrical output power 522. In some embodiments, output 522 can the same as V_PV provided to pulse generator 506 from PV cell 502. Electrical output power 522 can be provided to a DC optimizer circuit 520. A DC optimizer circuit 520 can alter a DC power out for compatibility with other circuits, such as inverters. In very particular embodiments, a DC optimizer 520 can include voltage regulators and/or DC to DC converters.

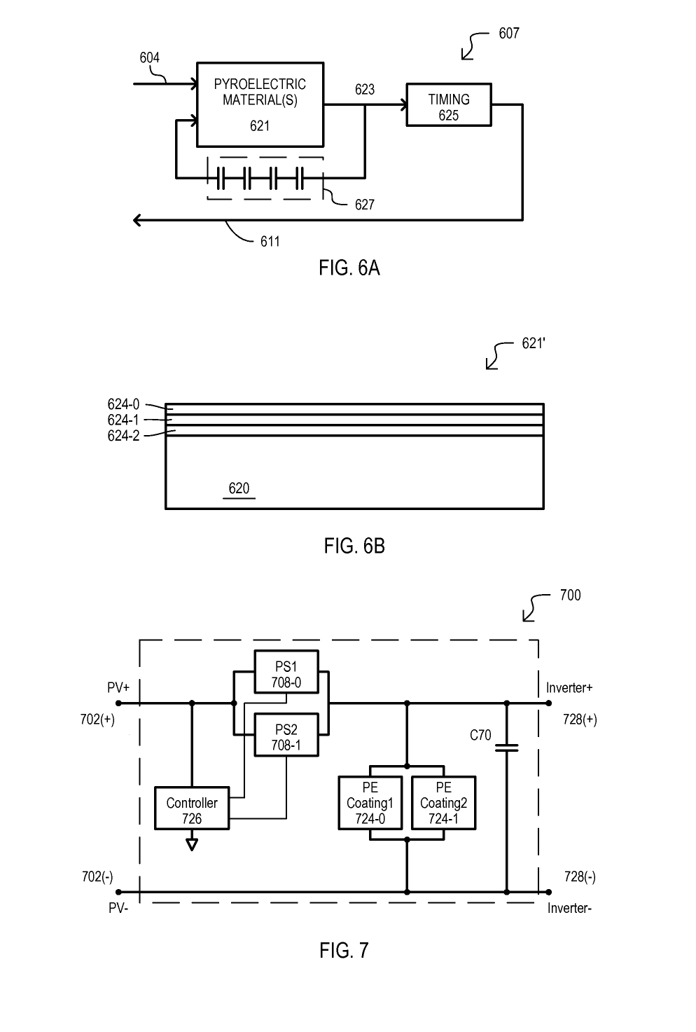

FIG. 6A is a block schematic diagram of a pyroelectric pulse source circuit 607 that can be included in embodiments. A pulse source circuit 607 can include pyroelectric material(s) section 621, pulse shaping circuit 625, and a timing circuit 627. Pyroelectric material(s) section 621 can include one or more pyroelectric materials that are used to generate electric pulses for application to a PV cell. It is understood that pyroelectric material(s) section 621 can include multiple pyroelectric materials with different dielectric constants, first pyroelectric material(s) operating according to a pyroelectric effect (i.e., generating a potential in response to a temperature gradient) while second pyroelectric material(s) can be polarized by the first pyroelectric material(s). A resulting oscillating electric field can generate initial electrical pulses 623.

A pulse shaping circuit 627 can shape initial electric pulses 623 and feed them back to the pyroelectric material(s) section 621. In this way, electric pulses can be generated having a desired duration and/or magnitude and/or polarity. While the embodiment of FIG. 6A depicts a pulse shaping circuit 627 as a capacitance in parallel with pyroelectric material(s) section 621, it is understood that a pulse shaping circuit 627 can include any suitable passive or active circuit elements to generate a desired pulse shape. In addition or alternatively, pulse shaping circuit 627 can shape pulses in a dynamic fashion, according to operating conditions of a system. As but two examples, pulse shaping can vary according to a detected temperature and/or a received output voltage of a PV solar cell.

A timing circuit 625 can alter or otherwise control pulses 623 output from pyroelectric material(s) section 621, to generate electric pulses 611 that are provided as an output. In embodiments disclosed herein, electric pulses 611 can be applied to a pulse shaper circuit, which can modify such pulses and then apply the modified pulses to a PV cell (e.g., to thereby alter the band gap of such materials).

The pulse generator of FIG. 6A is provided by way of example, and should not be construed as limiting.

FIG. 6B is a side cross sectional view of pyroelectric materials 621′ that can be included in embodiments. Pyroelectric materials 621′ can be used to generate electric pulses as described herein, or equivalents. Pyroelectric materials 621′ can include a number of pyroelectric thin films 624-0 to 624-2 (in the embodiment shown, three layers) formed on a substrate 620. In particular embodiments, pyroelectric thin films (624-0 to 624-2) can each be formed of different pyroelectric materials having different dielectric constants. It is noted that one or more and of the pyroelectric thin films (624-0 to 624-2) may not be polarized, but can behave as a good pyroelectric material upon being electrically biased (e.g., by application of PV solar cell output voltage).

Accordingly, in some embodiments, while a PV solar cell operates in response to photons received from sunlight, pyroelectric materials 621′ can operate in a pyroelectric fashion in response to heat from the sunlight, as well as be polarized upon being subjected to an electric field (i.e., a “reverse” pyroelectric effect). In some embodiments, the generated pulses can be modified and applied to a PV cell.

FIG. 7 is a block schematic diagram of a system 700 according to another embodiment. A system 700 can be connected to a PV cell (not shown) at PV connections 702(+) and 702(−) and to an inverter (not shown) at inverter connections 728(+) and 728(−). A system 700 can include pulse shaping circuits 708-0 and 708-1, a controller 726, pyroelectric materials 724-0 and 724-1 (e.g., thin films or coatings), and a capacitor C70.

According to well understood techniques, an inverter provided at connections 728(+) and 728(−) can generate an AC current/voltage from an output of PV cell (in this case via pulse shaping circuits (708-0 and 708-1)).

Pulse shaping circuits (708-0 and 708-1) can provide frequency modulation to electric pulses created by pyroelectric materials (724-0 and 724-1). A controller 726 can enable modification of the electric pulses generated by the pulse shaping circuits (724-0 and 724-1), including but not limited to, modifying pulse shape, height (i.e., magnitude), width (i.e., duration), and time between consecutive pulses that are used to modulate the pulses provided by pyroelectric materials (724-0 and 724-1). In a particular embodiment, one pulse shaping circuit (e.g., 724-0) modulates electric pulses going into the PV solar cell while the other (e.g., 724-1) modulates electric pulses coming out of the PV solar cell.

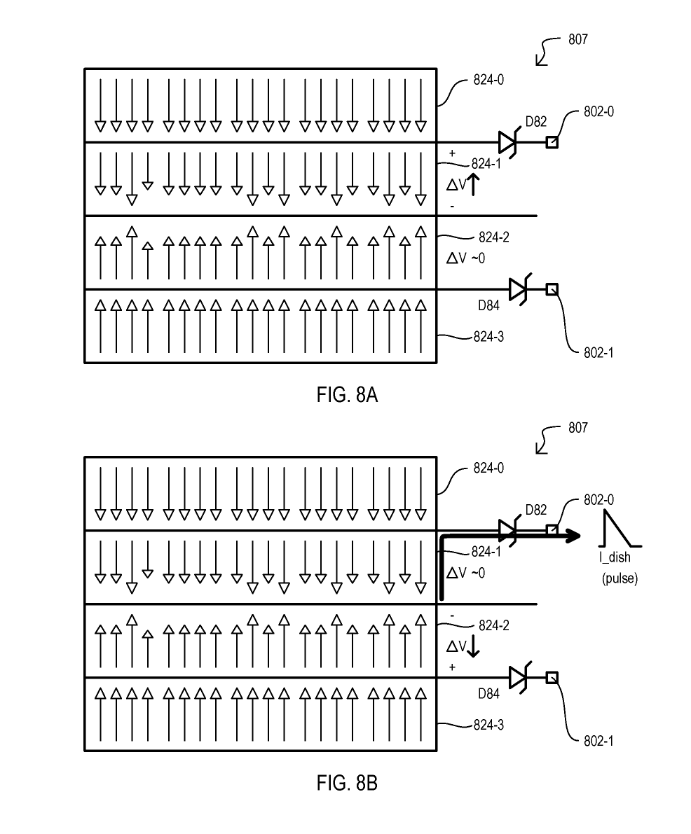

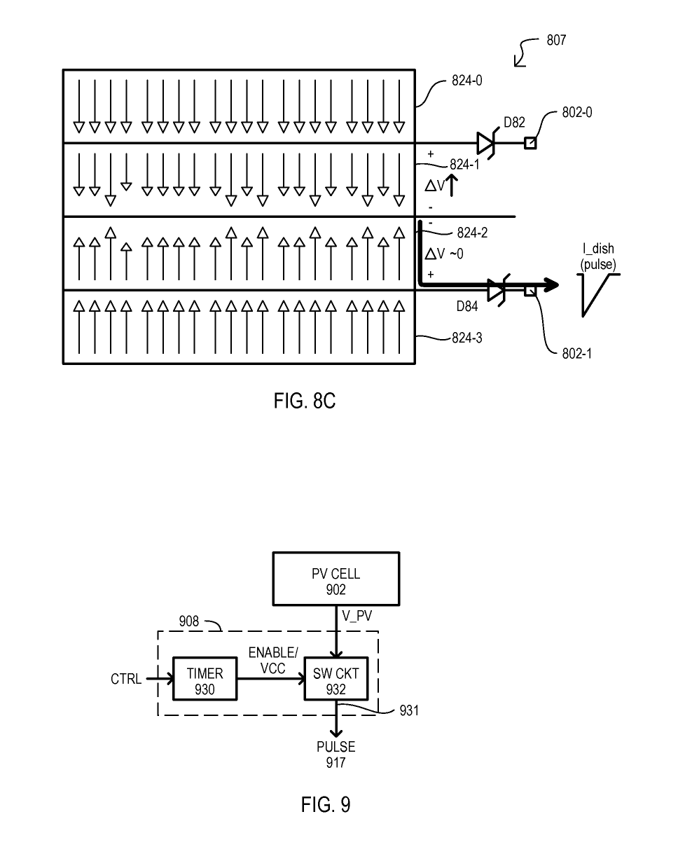

In embodiments described herein, the generation of electric pulses from one or more pyroelectric materials can be according to any suitable method. One very particular embodiment for extracting electric pulses is shown in FIG. 8A to 8C.

FIGS. 8A to 8C show a block diagram of a pyroelectric materials subsystem 807 according to an embodiment. Subsystem 807 can include pyroelectric materials 824-0 to 824-3 and diodes D82 and D84. Optionally, in the event the subsystem 807 is utilized to harvest energy from the pyroelectric materials (824-0 to 824-3), the subsystem 807 could also include a rectifier circuit (not shown) to capture alternating pulses at pulse outputs 808-0 and 808-1.

Pyroelectric materials (824-0 to 824-3) can be pyroelectric layers formed on a substrate. In such an arrangement, pyroelectric layers 824-0 and 824-1 can be top layers, while pyroelectric layers 824-2 and 824-3 can be bottom layers. That is, the pyroelectric layers (824-0 to 824-3) can be formed on a substrate (e.g., glass), but top pyroelectric layers (824-0 and 824-1) can be formed over bottom pyroelectric layers (824-2 and 824-3).

In general, subsystem 807 relies on a pair of pyroelectric layers (e.g., 824-1/2). A first pyroelectric layer can be polarized when subject to heat and/or induction from another layer. The electric layer field produced in the first pyroelectric layer can be used to reduce the electric field from a second pyroelectric layer. The first pyroelectric layer can then be discharged, to create an electric pulse, for example. Subsequently, the second pyroelectric layer can then be polarized when subject to heat and/or induction from another layer. The electric layer field produced in the second pyroelectric layer can be used to reduce the electric field in the first pyroelectric layer. The second pyroelectric layer can then be discharged, to create an electric pulse, for example. These processes can then repeat.

FIGS. 8A to 8C show pulse generating operations according to a particular embodiment. In FIG. 8A, pyroelectric layer 824-2 can be initially discharged by a system 807, and thus have little or no polarization. In response to induction from pyroelectric layer 824-0, pyroelectric layer 824-1 can polarize, to increase the charge generated by the layer.

FIG. 8B shows how pyroelectric layer 824-1 can be discharged to generate a pulse. Once a voltage across pyroelectric layer 824-1 exceeds a predetermined limit (in this case a Schottky diode threshold voltage), the layer can be discharged. While the embodiment of FIG. 8B utilizes a diode to extract charge from a polarized pyroelectric layer, any other suitable method can be employed. Subsequently, in response to induction from pyroelectric layer 824-1, pyroelectric layer 824-2 can polarize, to increase the charge generated by the layer.

FIG. 8C shows how pyroelectric layer 824-2 can be discharged to generate a pulse. Once a voltage across pyroelectric layer 824-2 exceeds a predetermined limit, the layer can be discharged.

As noted above, according to some embodiments, a system can include a pulse shaper circuit, which can generate electrical pulses by selectively outputting an output voltage from a PV cell.

FIG. 9 shows a pulse shaper circuit 908 that can be included in embodiments. A pulse shaper circuit 908 can receive a voltage V_PV from a PV cell 902, and output electric pulses 917 which can be mixed with pulses and applied to a PV cell, which can be the same as, or different than the PV cell 902. A pulse shaper circuit 908 can include a switch circuit 932 and a timing circuit 930. A switch circuit 932 can selectively connect a PV cell output voltage V_PV to an output node 931 in response to control signals from timer circuit 930. A timer circuit 930 can provide an enable signal ENABLE to switch circuit 932 which can control the closing and opening of switch circuit 932, and thus the pulse shape of electrical pulses 917 provided on output node 931. In some embodiments, a timer circuit 930 can also provide a power supply voltage (VCC) to switch circuit 932.

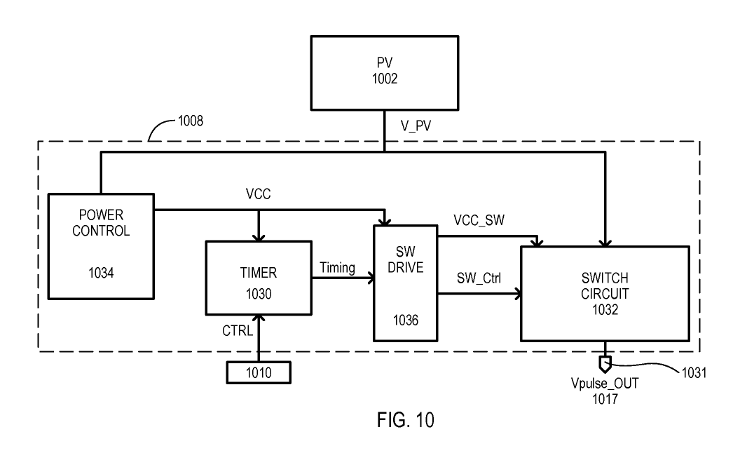

FIG. 10 shows a pulse shaper circuit 1008 according to another embodiment. A pulse shaper circuit 1008 can include a switch circuit 1032, a switch control circuit 1036, a timer circuit 1030, and a power control circuit 1034. A power control circuit 1034 can generate a power supply voltage VCC from a voltage V_PV provided from a PV cell. A power control circuit 1034 can include voltage regulator circuits, to ensure a stable voltage and necessary drive current for the other circuits of the pulse shaper circuit 1008. In addition or alternatively, a power control circuit 1034 can include level converter circuits to provide a desired DC voltage from the voltage V_PV, including step-down circuits or step-up circuits depending upon the circuitry employed. In FIG. 10, power control circuit 1034 provides a power supply voltage VCC.

A timer circuit 1030 can provide a timing signal (Timing). In one embodiment, a timing signal (Timing) can control a pulse width of electric pulses 1017 output from the pulse shaper circuit 1008. In particular embodiments, in response to a control signal (CTRL), a timer circuit 1030 can generate a periodic signal having the desired duty cycle for output pulses 1017. In the embodiment shown, a timer circuit 1030 can receive power from power supply voltage VCC.

A control signal (CTRL) can be generated from a control input 1010, which, in one particular embodiment can be a relay input. A controls signal (CTRL) can be activated, and thus enable the generation of timing signal (Timing), in response to predetermined conditions. As but a few possible examples, CTRL can be activated once PV cell 1002 is generating an adequate output voltage, and/or based on a temperature, and/or based on other circuit components being ready.

A switch driver circuit 1036 can activate a switch control signal SW_Ctrl, based on a timing signal (Timing). A switch driver circuit 1036 can be provided to ensure a sufficient drive signal is generated to control switch circuit 1032. In the embodiment shown, switch driver circuit 1036 can receive power from power supply voltage VCC. Further, switch driver circuit 1036 can provide a switch power supply voltage (VCC_SW) to switch circuit 1032. In one embodiment, switch power supply voltage (VCC_SW) can be generated from power supply voltage VCC.

A switch circuit 1032 can operate like that shown in FIG. 9, connecting an output voltage V_PV from a PV cell 1002 to an output node 1031 in response to switch control signal SW_Ctrl. In one embodiment, when SW_Ctrl is active, switch circuit 1032 can “close” driving output node 1031 to V_PV, and when SW_Ctrl is inactive, switch circuit 1032 can be “open”, isolating output node 1031 from V_PV. In the embodiment shown, switch circuit 1032 can receive a power supply voltage VCC_SW.

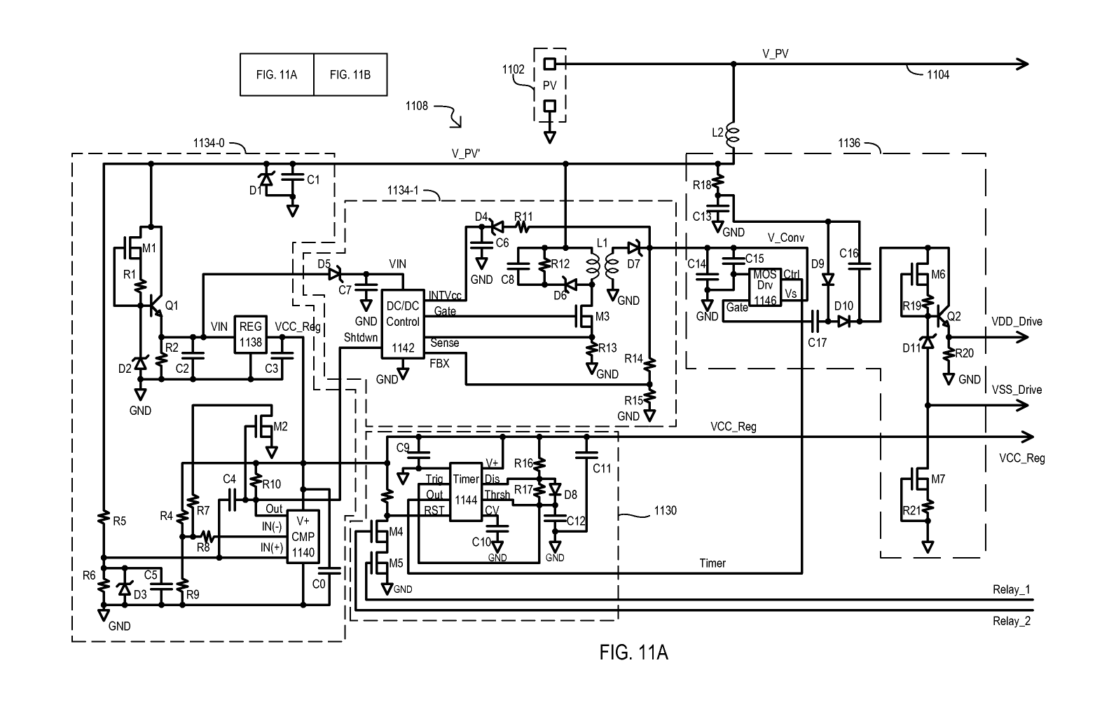

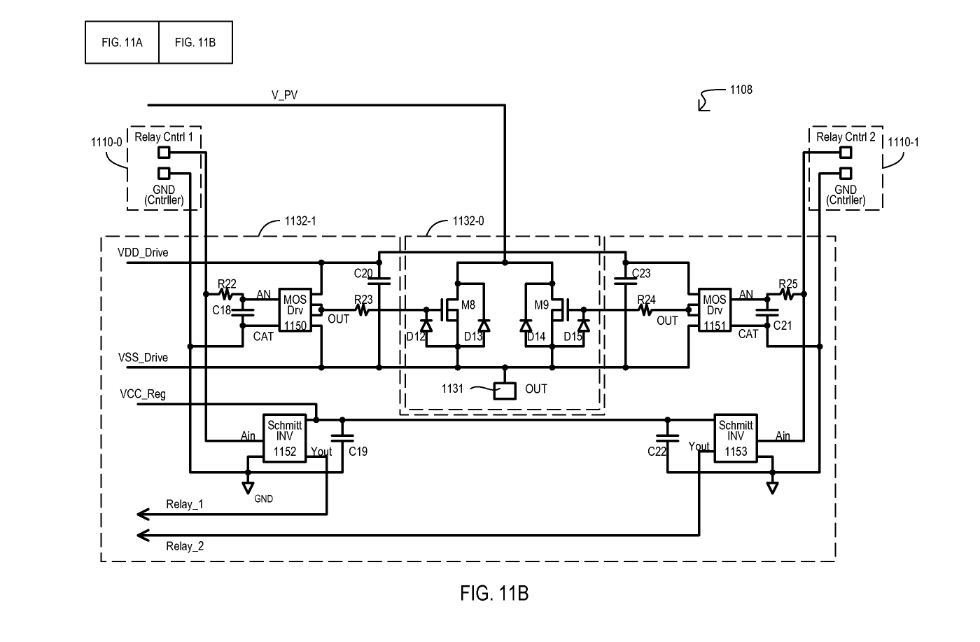

FIGS. 11A and 11B are a schematic diagram showing a pulse shaper circuit 1108 according to one embodiment. In one very particular embodiment, FIGS. 11A and 11B can be one implementation of the pulse shaper circuit shown in FIG. 10.

FIG. 11A shows a PV cell input 1102, which can receive an input voltage V_PV 1104 from PV cell (not shown). PV cell output voltage V_PV can be provided as a voltage V_PV′ through inductor L2. FIG. 11A shows a voltage regulator section 1134-0, a voltage converter section 1134-1, a timer circuit 1130, and a switch driver circuit 1136. A voltage regulator section 1134-0 can generate an input voltage VIN from V_PV, and generate a regulated power supply voltage VCC_Reg from VIN. In the particular embodiment shown, voltage regulator section 1134-0 can include diodes D1-D3, capacitors C0-C5, n-channel MOS transistors M1, M2, bipolar transistor Q1, resistors R1 and R2-R10, regulator integrated circuit (IC) 1138 and comparator IC 1140. In one particular embodiment, regulator IC 1138 can be an MC78LC00 series voltage regulator manufactured by On Semiconductor, and a comparator IC 1140 can be LM393 comparator manufactured by Fairchild Semiconductor.

A voltage converter section 1134-1 can convert voltage V_PV′ to driver voltage V_Conv. In the particular embodiment shown voltage converter section 1134-1 can include diodes D4-D7, capacitors C6-C8, n-channel MOS transistor M3, resistors R11-R15, and a DC/DC controller IC 1142. In one particular embodiment, flyback controller IC 1142 can be an LT3758 series DC-DC controller manufactured by Linear Technology.

A timer circuit 1130 can generate a timing signal (Timer), which can be a periodic signal. Timer circuit 1130 can be enabled when two control signals (Relay_1, Relay_2) are active (high, in the embodiment shown). In the embodiment shown, timer circuit 1130 can include diode D8, capacitors C9-C12, n-channel MOS transistors M4-M5, resistors R16-R17, and a timer IC 1144. In one particular embodiment, timer IC 1144 can be an NE555 series timer IC manufactured by Fairchild Semiconductor.

A switch driver circuit 1136 can generate drive signals VDD_Drive and VSS_Drive in response to timer signal (Timer). Switch driver circuit 1136 can receive V_Conv as a power supply voltage, and utilize V_PV′ to generate VDD_Drive. In the embodiment shown, switch driver circuit 1136 can include diodes D9-D11, capacitors C13-C17, n-channel MOS transistors M6-M7, bipolar transistor Q2, resistors R18-R21, and a driver IC 1146. In one particular embodiment, driver IC 1146 can be an MIC4416 Low-Side MOSFET Driver IC manufactured by Micrel, Inc.

Referring now to FIG. 11B, a remaining portion of a pulse shaper circuit 1108 can include switch circuit 1132-0, switch input circuit 1132-1, and relay control inputs 1110-0/1. Switch circuit 1132-0 can include switches formed by MOS transistors M8 and M9, and corresponding blocking diodes D12 to D15. When enabled MOS transistors M8/M9 can provide an electrical path between V_PV (provided from a PV cell) and an output node 1131.

Switch input circuit 1132-1 can enable switch circuit 1132-0 in response to driver signals VDD_Drive and VSS_Drive. In the embodiment shown, switch input circuit 1132-1 can include capacitors C18-C23, resistors R22-R25, driver ICs 1150/1151, and Schmitt trigger ICs 1152/1153. In one particular embodiment, driver ICs 1150/1151 can be FOD3182 MOSFET Gate Driver Optocoupler ICs manufactured by Fairchild Semiconductor Corporation. Schmitt trigger ICs can be SN74LVC1G14 Schmitt Trigger Inverter ICs manufactured by Texas Instruments Incorporated.

Relay control inputs 1110-0 and 1110-1 can control the activation of timer circuit 1130 (in FIG. 11A) and control the enabling of switching transistors M8 and M9, respectively.

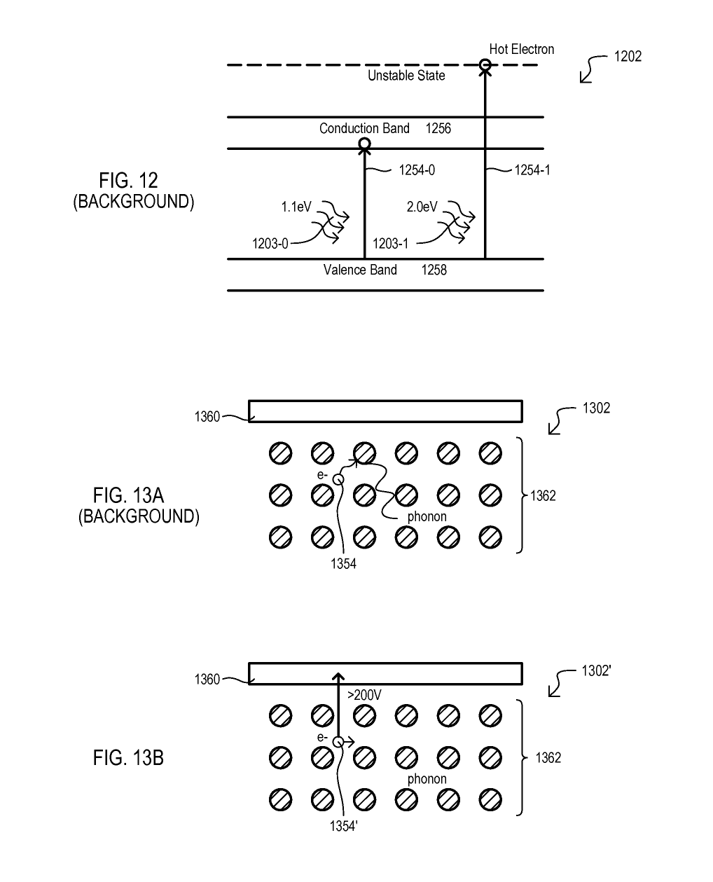

FIG. 12 is a diagram showing how a conventional PV solar cell will lose the energy of a hot carrier. FIG. 12 shows a PV solar cell 1202 with a semiconductor material having a valence band 1258 and a conduction band 1256. A photon 1203-0 having appropriate energy can excite an electron 1254-0 in the valence band 1258 so that it jumps to the conduction band 1256. However, higher energy photon 1203-1 can generate a hot carrier, in this case an electron 1254-1, which can enter a higher energy state. Such an electron can lose some or all of its energy by collisions within a lattice.

FIG. 13A is a diagram of a PV solar cell 1302 having an electrode 1360 and crystal lattice 1362. A hot carrier (in this case electron 1354) can be generated by an incident photon of sufficient energy. As shown, the electron 1354 can collide with a lattice site to generate a phonon. A phonon represent the thermalization of the hot carrier energy, resulting in the electron 1354 failing to flow to the electrode 1360.

FIG. 13B is a diagram of a PV solar cell 1302′ operating according to an embodiment. Unlike FIG. 13A, PV solar cell 1302′ can be biased with a relatively large electric pulse. Consequently, a hot carrier (in this case electron 1354′) can be attracted to an electrode 1360 before colliding with a lattice site. In some embodiments, an electric pulse can be generated with one or more pyroelectric materials.

Having described the absorption of hot carriers according to an embodiment, various aspects of hot carriers will now be discussed. A semiconductor material of a PV solar cell can have a band gap given by E_{g}. An incident photon can have an energy of Eₚₕ=hυ=hc/λ; where h=Planck's constant, υ=frequency of light, c=the speed of light, and λ=wavelength of the light. If Eₚₕ>E_{g}, an electron-hole pair can be generated in the semiconductor material. The kinetic energy of the electron (of mass mₑ and velocity vₑ) can be given by,

$$\frac{1}{2} {m}_{e} {v}_{e}^{2} = ( hv - Eg )$$

which can yield an electron velocity (vₑ) of

$${v}_{e} = \sqrt{\frac{2 ( hv - {E}_{g} )}{{m}_{e}}} .$$

An electron can lose excess energy by collisions with a lattice to generate lattice vibrations (thermalization). An average energy of an electron after thermalization can be given by E_{g}+6kT/2, where k is the Boltzmann constant and T temperature. Thus, energy lost by an electron due to thermalization can be given as:

$$Δ E = hv - ( {E}_{g} + \frac{3}{2} kT )$$

From this, the average power lost due to heat in a conventional PV solar cell can be:

$${P}_{H} = ( \frac{{P}_{L}}{hv} ) Δ E$$

where PL is the power of the incident light.

As a particular example, silicon can have a band gap of 1.12 eV and red light from the solar spectrum can have λ=650 nm. In such an arrangement the average energy of electrons after thermalization can be:

E_{avg}=(E_{g}+6 kT/2)=1.12 eV+(6/2)(0.0259)eV=1.16 eV

The energy of an incident photon can be

$$hv = \frac{hc}{λ} = 1.91 eV$$

and the energy lost be each incident electron can be

$$\begin{matrix}Δ E = hv - ( {E}_{g} + \frac{3}{2} kT ) \\ = 1.91 eV - 1.16 eV \\ = 0.75 eV\end{matrix}$$

and given an average power P_{L}=1.65 kW/m², the average dissipated power can be

P_{H}=((1.65 kW/m²)/1.91 eV)*(0.75 eV)=0.56 kW/m².

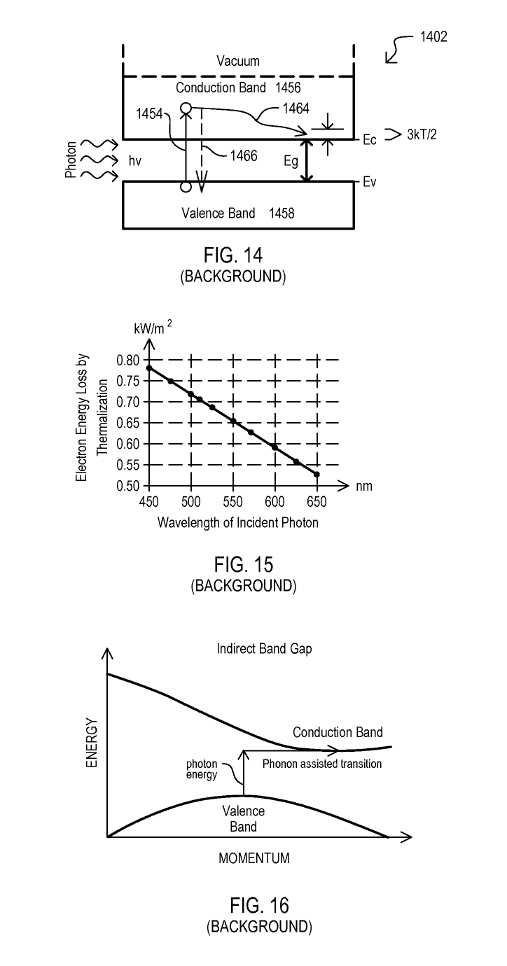

FIG. 14 is a diagram showing the hot carrier mechanism in a semiconductor material. A hot carrier 1454 can be generated that exits the valence band 1458 and enters a high energy state. In some cases, due to thermalization, a hot carrier 1454 can lose essentially all of its energy via path 1466, and thus never contribute to a PV solar cell current. In other cases, the hot carrier 1454 may lose less energy (e.g., 3/2 kT, as described above), to remain in the conduction band 1456.

FIG. 15 is a graph showing electron loss due to thermalization versus a wavelength of the incident light for silicon as the semiconductor material.

As shown above, in a PV solar cell semiconductor material, excess energy (i.e., energy beyond the band gap) can be lost as phonons in lattice collisions. However, appropriate phonons can be used to increase the life of hot carriers, to enable the capture of more hot carriers. In an indirect band gap semiconductor, such as silicon, phonons can be involved in band to band transitions of an electron. This is shown in FIG. 16. A carrier can be generated by a photon, and can transition from a valence band to the conduction with the assistance of a phonon in order to conserve momentum.

From the above, it is understood that a semiconductor material can be conceptualized as including both an electronic band gap as well as a “phonon band gap”. The electronic band gap arises from interaction between periodic electrostatic forces within a lattice. At the same time, a phonon band gap can also exist within a semiconductor material due to mechanical movement within lattice sites.

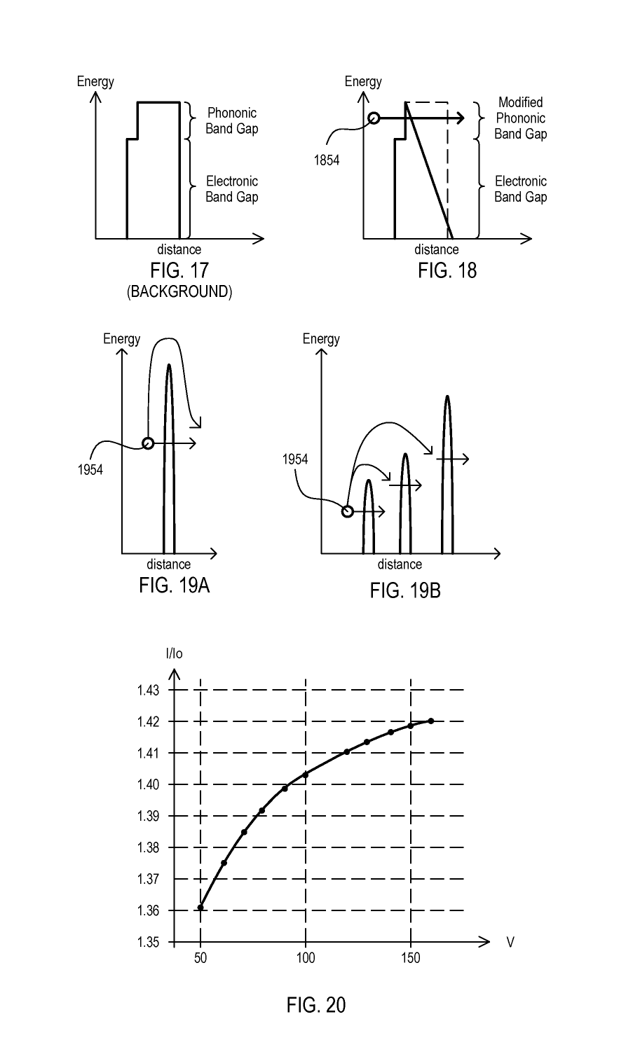

FIG. 17 is a diagram representing a potential barrier arising from both an electronic band gap and phononic bad gap. FIG. 18 shows how the application of an electric voltage pulse can bend the potential barrier, allowing more (or increasing the probability) of such carriers (e.g., 1854) passing through the quantum mechanical barrier presented by the band gaps.

FIG. 19A is a diagram showing how an electric pulse can enable a carrier (1954) to pass a band gap barrier. FIG. 14B is a diagram showing sequence of modified bad gaps resulting from a sequence of electric pulses.

FIG. 20 is a graph showing simulation results that demonstrate an increase in output current of a PV solar cell versus the amplitude of electric pulses applied to the cell. “I” is the increased output current, and “Io” is a baseline current (a current absent the electric pulses).

According to embodiments, the thermalization of carriers can be slowed by application of electric pulses. By way of example, a lattice (e.g., silicon lattice) can have a lattice constant given by a₀. Thus, the maximum distance travelled by a photon generated carrier (e.g., electron) can be a₀. A travel time of a carrier with a velocity vₑ before it reaches a lattice site can be given by

$$\begin{matrix}{t}_{H} = {a}_{0} / {v}_{e} . \\ = {a}_{0} \sqrt{\frac{{m}_{e}}{2 ( hv - {E}_{g} )}} \\ = {a}_{0} \sqrt{\frac{{m}_{e}}{2 ( hc / λ ) - {E}_{g}}}\end{matrix}$$

where mₑ is the mass of the carrier.

Using the above relationship, assuming a silicon lattice (a₀=5.46×10⁻¹⁰ m, E_{g}=1.12 eV) and red light (λ=6×10⁻⁷ m), a carrier travel time will be t_{H}=1.06 femtoseconds (fs).

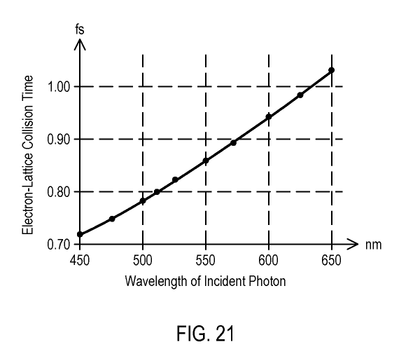

FIG. 21 is a graph showing simulated electron travel times in a silicon lattice versus the wavelength of incident light.

While embodiments herein have disclosed particular semiconductor materials and electric pulse generating methods and circuits, such particular embodiments should not be construed as limiting. Alternate embodiments can include different materials and/or any suitable electric pulse duration, amplitude, waveshape, etc.

It should be appreciated that reference throughout this description to “one embodiment” or “an embodiment” means that a particular feature, structure or characteristic described in connection with the embodiment is included in at least one embodiment of an invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

It is also understood that other embodiments of this invention may be practiced in the absence of an element/step not specifically disclosed herein. Further, while embodiments can disclose actions/operations in a particular order, alternate embodiments may perform such actions/operations in a different order.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claims require more features than are expressly recited in each claim. Rather, inventive aspects lie in less than all features of a single foregoing disclosed embodiment. Thus, the claims following the detailed description are hereby expressly incorporated into this detailed description, with each claim standing on its own as a separate embodiment of this invention.

1. A system, comprising:
at least one photovoltaic (PV) cell comprising a semiconductor material having p-n junctions formed therein, and configured to generate a PV output voltage in response to light; and
a pulse generator coupled to receive a PV output voltage and generate electric output pulses therefrom, and apply such pulses to the PV cell.

2. The system of claim 1, wherein:
the pulse generator comprises
a pulse source circuit configured to supply first electric pulses, and
a pulse shaper circuit coupled to the receive the first electric pulses, and configured to alter such pulses to generate the output pulses.

3. The system of claim 1, wherein:
the pulse source circuit comprises at least one pyroelectric material that generates an electric potential in response to a temperature gradient, the electric potential applied to form at least a portion of the first electric pulses.

4. The system of claim 3, wherein:
the pulse generator comprises a plurality of different pyroelectric materials.

5. The system of claim 2, wherein:
the pulse shaper circuit includes
a pulse formation circuit configured to generate a time varying electric waveform from the PV output voltage, and
a modulation circuit configured to modulate the first electric pulses with the time varying electric waveform.

6. The system of claim 2, wherein:
the pulse shaper circuit includes
a switch circuit configured to selectively couple the PV output voltage to a pulse shaper output node in response to at least one control signal.

7. The system of claim 6, wherein:
the pulse shaper circuit further includes
a power supply circuit coupled to receive the PV output voltage and generate a control power supply voltage therefrom,
a timer circuit that receives the control power supply voltage and is configured to control activation of the at least one control signal.

8. The system of claim 7, wherein:
at least one relay configured to enable the at least one control signal when activated.

9. The system of claim 1, wherein:
the pulse generator is configured to generate sequences of output pulses, where the output pulses of each sequence decrease in amplitude.

10. A system, comprising:
at least one photovoltaic (PV) cell comprising a semiconductor material having p-n junctions formed therein, and configured to generate a PV output voltage in response to light; and
a pulse shaping circuit coupled to receive power from the PV output voltage, and configured to receive and modify first electric pulses to generate output pulses coupled to the PV cell.

11. The system of claim 1, wherein:
the pulse shaping circuit comprises
a switch circuit that includes at least one switch element configured to couple the PV output voltage to a switching circuit output in response to at least one control input.

12. The system of claim 1, wherein:
the pulse shaping circuit further includes
a switch control circuit configured to control the switch circuit in response to at least one control input.

13. The system of claim 1, wherein:
the at least one control input is a relay input.

14. The system of claim 1, further including:
a pulse source circuit comprising at least one pyroelectric material that generates an electric potential in response to a temperature gradient, the electric potential applied to form at least a portion of the first electric pulses; and
the pulse shaping circuit is configured to generate second electric pulses for combination with the first electric pulses to generate the output pulses.

15. A method, comprising:
generating first electric pulses;
modifying the first electric pulses in response to a control input to generate second electric pulses;
applying the second pulses to at least one photovoltaic (PV) cell while the cell receives photons; and
generating electric power from the PV cell.

16. The method of claim 15, wherein:
generating the first electric pulses includes generating the first electric pulses with a plurality of pyroelectric materials having different dielectric constants.

17. The method of claim 15, wherein:
modifying the first electric pulses includes generating sequences of second electric pulses of decreasing amplitude.

18. The method of claim 15, wherein:
modifying the first electric pulses includes
generating second electric pulses, and
modulating the first electric pulses with the second electric pulses.

19. The method of claim 18, wherein:
generating the second pulses includes coupling an output voltage of the PV cell to an output node based on a timing signal.

20. The method of claim 15, wherein:
the control input comprises a relay input.
